(19) United States
(12) Patent Application Publication
(10) Pub. No.: US 2026/0162658 A1
(43) Pub. Date: Jun. 11, 2026

(54) ELECTRONIC DEVICE AND METHOD FOR CONTROLLING SAME

(71) Applicant: Samsung Electronics Co., Ltd., Suwon-si (KR)

(72) Inventors: Jinhwan PARK, Suwon-si (KR); Sungsoo KIM, Suwon-si (KR); Sichen JIN, Suwon-si (KR); Changwoo HAN, Suwon-si (KR)

(21) Appl. No.: 19/179,546

(22) Filed: Apr. 15, 2025

Related U.S. Application Data
(63) Continuation of application No. PCT/KR2023/015379, filed on Oct. 6, 2023.

(30) Foreign Application Priority Data
Nov. 11, 2022 (KR) 10-2022-0150675

(51) Int. Cl. G10L 15/22; G10L 21/02

(52) U.S. Cl. CPC G10L 15/22; G10L 21/02

(57) ABSTRACT

An electronic device is provided. The electronic device includes memory storing one or more computer programs, and one or more processors communicatively coupled to the memory, wherein the one or more computer programs include computer-executable instructions that, when executed by the one or more processors individually or collectively, cause the electronic device to obtain first audio data including a user's voice, obtain second audio data through acoustic augmentation on the first audio data, obtain a first section corresponding to audio data between time point at which a user speech is included among the first audio data and a second section of the second audio data corresponding to the first section, calculate a plurality of first scores corresponding to each of the plurality of estimation candidates based on the first audio data corresponding to the first section, calculate a plurality of second scores corresponding to each of the plurality of estimation candidates based on the second audio data corresponding to the second section, and determine one estimation candidate from among the plurality of estimation candidates as character data based on the plurality of first scores and the plurality of second scores.

### CROSS-REFERENCE TO RELATED APPLICATION(S)

This application is a continuation application, claiming priority under 35 U.S.C. § 365(c), of an International application No. PCT/KR2023/015379, filed on October 6, 2023, which is based on and claims the benefit of a Korean patent application number 10-2022-0150675, filed on November 11, 2022, in the Korean Intellectual Property Office, the disclosure of which is incorporated by reference herein in its entirety.

### BACKGROUND

### 1. Field

The disclosure relates to an electronic device related to an artificial intelligence (AI) learning algorithm and a method for controlling the same. More particularly, the disclosure relates to an electronic device including a decoding process for enhancing performance of a trained AI model and a method for controlling the same.

### 2. Description of Related Art

An AI system is a computer system implementing human-level intelligence and is a system by which a machine may learn, determine, and develop by itself differently from the existing rule-based smart system.

A voice recognition technology to which an AI technology to which the AI system as above is applied applies is a technology of recognizing and applying/processing a language/character of a human. Here, a voice recognition model for the voice recognition technology may perform natural language processing, machine translation, a conversation system, query response, voice recognition/synthesis, etc.

More particularly, the trained voice recognition model may show an incorrect voice recognition result with respect to audio data different from learning data. Therefore, acoustic augmentation may be used for more accurate voice recognition of the voice recognition model trained with limited audio data.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device including a decoding process for enhancing performance of a trained AI model and a method for controlling the same.

Additional aspects will be set forth in part in the description which follows and, in part, will be apparent from the description, or may be learned by practice of the presented embodiments.

In accordance with an aspect of the disclosure, an electronic device is provided. The electronic device includes memory storing one or more computer programs and one or more processors communicatively coupled to the memory, wherein the one or more computer programs include computer-executable instructions that, when executed by the one or more processors individually or collectively, cause the electronic device to obtain first audio data including a user voice, obtain second audio data through acoustic augmentation on the first audio data, obtain a first section corresponding to audio data between time points at which a user speech is included among the first audio data and a second section of the second audio data corresponding to the first section, calculate a plurality of first scores corresponding to each of a plurality of estimation candidates based on the first audio data corresponding to the first section, calculate a plurality of second scores corresponding to each of the plurality of estimation candidates based on the second audio data corresponding to the second section, and determine one estimation candidate among the plurality of estimation candidate as character data based on the plurality of first scores and the plurality of second scores.

In accordance with another aspect of the disclosure, a method performed by an electronic device is provided. The method includes obtaining first audio data including a user voice, obtaining, by the electronic device, second audio data through acoustic augmentation on the first audio data, obtaining, by the electronic device, a first section corresponding to audio data between time points at which a user speech is included among the first audio data and a second section of the second audio data corresponding to the first section, calculating, by the electronic device, a plurality of first scores corresponding to each of a plurality of estimation candidates based on the first audio data corresponding to the first section, calculating, by the electronic device, a plurality of second scores corresponding to each of the plurality of estimation candidates based on the second audio data corresponding to the second section, and determining, by the electronic device, one estimation candidate among the plurality of estimation candidates as character data based on the plurality of first scores and the plurality of second scores.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include obtaining first audio data including a user voice, performing, by the electronic device, acoustic augmentation on the first audio data to obtain second audio data, obtaining, by the electronic device, a first section corresponding to audio data between time points at which a user speech is included among the first audio data and a second section of the second audio data corresponding to the first section, calculating, by the electronic device, a plurality of first scores corresponding to each of a plurality of estimation candidates based on the first audio data corresponding to the first section, calculating, by the electronic device, a plurality of second scores corresponding to each of the plurality of estimation candidates based on the second audio data corresponding to the second section, and determining, by the electronic device, one estimation candidate among the plurality of estimation candidates as character data based on the plurality of first scores and the plurality of second scores.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating an electronic device according to an embodiment of the disclosure;

FIG. 2 is a block diagram illustrating a configuration of an electronic device according to an embodiment of the disclosure;

FIG. 3 is a block diagram illustrating a configuration of an electronic device according to an embodiment of the disclosure;

FIG. 4 is a view illustrating a voice recognition process of an electronic device according to an embodiment of the disclosure;

FIG. 5 is a view illustrating a process of determining character data of an electronic device according to an embodiment of the disclosure;

FIG. 6 is a view illustrating a process of obtaining a plurality of first sections and a plurality of second sections according to an embodiment of the disclosure; and

FIG. 7 is a flowchart illustrating a method of controlling an electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the disclosure, the expression, such as “have,” “may have,” “include”, or “may include” denotes the existence of such a characteristic (e.g., a numerical value, a function, an operation, or a component, such as a part), and the expression does not exclude the existence of an additional characteristic.

In the disclosure, the expression “A or B”, “at least one of A and/or B”, “one or more of A and/or B”, or the like may include all possible combinations of the listed items. For example, “A or B”, “at least one of A and B”, or “at least one of A or B” may refer to all of the following cases (1) including at least one A, (2) including at least one B, or (3) including all of at least one A and at least one B.

The expression “1^{st}”, “2^{nd}”, “first”, “second”, or the like used in the disclosure may be used to describe various elements regardless of any order and/or degree of importance, wherein the expression is used only to distinguish one element from another element and is not intended to limit the elements.

Meanwhile, the description that one element (e.g., a first element) is “(operatively or communicatively) coupled with/to” or “connected to” another element (e.g., a second element) should be interpreted such that the one element is directly coupled to the another element or the one element is coupled to the another element through the other element (e.g., a third element).

In contrast, the description that one element (e.g., a first element) is “directly coupled” or “directly connected” to another element (e.g., a second element) may be interpreted to mean that the other element (e.g., a third element) is not present between the one element and the another element.

The expression “configured to” used in the disclosure may be interchangeably used with other expressions, for example, “suitable for”, “having the capacity to”, “designed to”, “adapted to”, “made to”, or “capable of” depending on circumstances. The term “configured to (or set to)” may not necessarily mean that a device is “specifically designed to” do in terms of hardware.

Instead, under some circumstances, the expression “a device configured to” may mean that the device “is capable of” performing an operation together with another device or component. For example, the phrase “a processor configured to (set to) perform A, B, and C” may mean a dedicated processor for performing the corresponding operations (e.g., an embedded processor), or a generic-purpose processor that may perform the corresponding operations by executing one or more software programs stored in memory (e.g., a central processing unit (CPU) or an application processor).

In embodiments of the disclosure, a ‘module’ or ‘part’ may perform at least one function or operation and may be implemented as hardware or software, or as a combination of hardware and software. In addition, a plurality of ‘modules’ or ‘parts’ may be integrated into at least one module and implemented as at least one processor, excluding a ‘module’ or ‘part’ that needs to be implemented as specific hardware.

Meanwhile, various elements and areas in the drawings are illustrated schematically. Accordingly, the technical idea of the disclosure is not limited by the relative sizes or intervals illustrated in the appended drawings.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth^{TM} chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

Hereinafter, with reference to the appended drawings, an embodiment according to the disclosure is specifically described to be easily embodied by those skilled in the art.

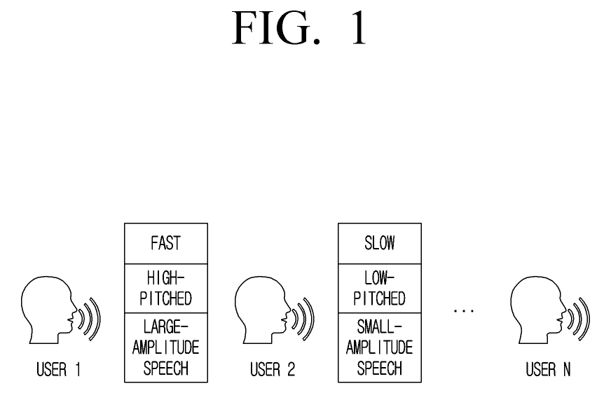

FIG. 1 is a view illustrating an electronic device according to an embodiment of the disclosure.

Referring to FIG. 1, in spite of the same sentence, a user speech may include a different voice characteristic according to a user. More particularly, the user speech may include various voice characteristics, such as a speed, a pitch, an amplitude, and the like, and various users may speech at various speeds, pitches, and magnitudes with respect to the same sentence. For example, a speech speed of a user 1 may be fast, a speech pitch may be high-pitched, and a speech amplitude may be large. In contrast, a speech speed of a user 2 may be slow, a speech pitch may be low-pitched, and a speech amplitude may be small. Various voice characteristics as above may be different according to an age, a gender, a health condition, or the like of the user.

Otherwise, even in the case of a speech of the same user, in spite of the same user, the speech may be a speech including different voice characteristics according to a place where the user is positioned or a distance from the user to the voice recognition model. For example, reverberation may be larger in a case that the user speeches in a bathroom compared to a case that the user speeches in a living room or a room at home. Otherwise, in a case of the outside compared to the interior, a noise incurred from a surrounding environment may be included in the user speech or in a case that a distance between the user and the voice recognition model is far, the case may affect the voice characteristics.

Therefore, the voice recognition model is required to recognize the user speech as the same character data under consideration of various voice characteristics with respect to the user speech about the same sentence.

As above, in the case of the voice recognition model for recognizing the user speech including various voice characteristics, to train it based on data including the various voice characteristics may be a factor priorly determining voice recognition performance. For example, since it learns sound, a voice, and a linguistic variation required for voice recognition based on transcription data of a voice-character pair, a large amount of transcription data including various voice characteristics is required for robust modeling. However, it may be difficult to collect transcription data including all voice characteristics to train the voice recognition model because to collect the large amount of data consumes a lot of costs and time. In addition, in spite of training the voice recognition model by using limited transcription data and then, collecting new transcription data, to retrain the voice recognition model may consume a lot of costs and time.

Therefore, to enhance recognition performance of the already trained voice recognition model, the augmented audio data may be obtained by performing acoustic augmentation on original audio data, and the original audio data and the augmented audio data may be used in a decoder at the same time.

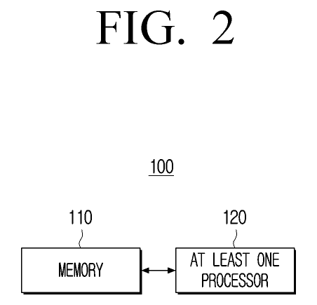

FIG. 2 is a block diagram illustrating a configuration of an electronic device according to an embodiment of the disclosure.

Referring to FIG. 2, an electronic device 100 may include memory 110, and at least one processor 120. However, a configuration of the electronic device 100 shown in FIG. 2 is merely an example, wherein it is obvious that another configuration may be added or a partial configuration may be omitted.

The electronic device 100 may include a computer or a user terminal device, such as, for example, a smart television (TV), a tablet personal computer (PC), a monitor, a smart phone, a desktop computer, a laptop computer, a mobile device, or a wearable device.

The electronic device 100 may include a home appliance, such as an air conditioner, a washing machine, a refrigerator, a speaker, an iron, a coffee pot, a vacuum cleaner, a dishwasher, an electric range, a gas range, an induction range, a fan, a cleaning robot, a serving robot, or a medical robot.

More particularly, the electronic device 100 may train the voice recognition model by interaction between memory 110 and a processor 120 and perform a voice recognition function through the voice recognition model.

According to an embodiment of the disclosure, the memory 110 may store an operating system (OS) for controlling an overall operation of components of the electronic device 100 and instructions or data related to the components of the electronic device 100. More particularly, the memory 110 may store an image obtained by photographing by a camera or capturing a display image. Otherwise, it may store an image obtained through a communication interface. Further, to display a text image included in the obtained image as a substitute text image, the memory 110 may store instructions or data for generating the substitute text image. As above, the memory110 may include, for example, at least one of main storage or auxiliary storage. The main memory may be implemented by using a semiconductor storage medium, such as read only memory (ROM) and/or random access memory (RAM). The ROM may include, for example, general ROM, erasable programmable ROM (EPROM), electrically erasable programmable ROM (EEPROM), and/or masked ROM (MASK-ROM). The RAM may include, for example, dynamic RAM (DRAM) and/or static RAM (SRAM). Auxiliary storage may be implemented by using at least one storage medium which may permanently or semi-permanently store data, such as flash memory device, secure digital (SD) card, solid state drive (SSD), hard disk drive (HDD), a magnetic drum, an optical medium, such as a compact disc (CD), digital versatile disc (DVD), or a laser disc, a magnetic tape, a magneto-optical disk and/or a floppy disk.

More particularly, the memory 110 may store the voice recognition model trained by limited transcription data. For example, the electronic device 100 may determine character data corresponding to audio data through the voice recognition model stored in the memory 110.

In addition, the memory 110 may store a decoder. Here, the decoder may output a probability about character data recognized from an initial time point to a time point before a recognition time point and character data including an estimation candidate character of the recognition time point based on a probability value about audio data of a recognition time point outputted from the voice recognition model. Here, the probability about character data may be expressed as a score.

According to an embodiment of the disclosure, at least one processor 120 controls operations of the electronic device 100 overall.

According to an example of the disclosure, the at least processor 120 may be implemented as a digital signal processor (DSP) processing a digital signal, a microprocessor, or a time controller (TCON). Meanwhile, the disclosure is not limited thereto and it may include one or more of a central processing unit (CPU), a micro controller unit (MCU), a micro processing unit (MPU), a controller, an application processor (AP), or a communication processor (CP), an advanced reduced instruction set computer (RISC) machine (ARM) processor, or an AI processor or may be defined by the relevant terms. In addition, the at least one processor 120 may be implemented as a system on chip (SoC) on which a processing algorithm is embedded or a large scale integration (LSI) and may be implemented as a field programmable gate array (FPGA). The at least one processor 120 may perform various functions by executing computer executable instructions stored in the memory.

At least one processor 120 may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The at least one processor 120 may control one or any combination of other components of the electronic device and perform an operation related to communication or data processing. The at least one processor 120 may perform at least one program or instruction stored in the memory. For example, the at least one processor 120 may perform a method according to an embodiment of the disclosure by executing at least one instruction stored in the memory.

If a method according to an embodiment of the disclosure includes a plurality of operations, the plurality of operations may be performed by one processor and may be performed by a plurality of processors. For example, when a first operation, a second operation, and a third operation are performed by a method according to an embodiment of the disclosure, all of the first operation, the second operation, and the third operation may be performed by a first processor and also, the first operation and the second operation are performed by the first processor (e.g., a general purpose processor) and the third operation may be performed by a second processor (e.g., an artificial intelligence (AI)-dedicated processor).

The at least one processor 120 may be implemented as a single core processor including one core and may be implemented as at least one multi core processor including a plurality of cores (e.g., homogeneous multicores or heterogeneous multicores). If the at least one processor 120 is implemented as a multi core processor, each of the plurality of cores included in the multi core processor may include processor internal memory, such as cache memory and on-chip memory, wherein a common cache shared by the plurality of cores may be included in the multi core processor. In addition, each of the plurality of cores included in the multi core processor (or part of the plurality of cores) may read and perform program instructions for independently implementing a method according to an embodiment of the disclosure and also, may read and perform program instructions for implementing a method according to an embodiment of the disclosure in connection with all (or part) of the plurality of cores.

If a method according to an embodiment of the disclosure includes a plurality of operations, the plurality of operations may be performed by one core among the plurality of cores included in the multi core processor and may be performed by the plurality of cores. For example, when a first operation, a second operation, and a third operation are performed by a method according to an embodiment of the disclosure, all of the first operation, the second operation, and the third operation may be performed by a first core included in the multi core processor and also, the first operation and the second operation may be performed by the first core included in the multi core processor and the third operation may be performed by the second core included in the multi core processor.

In embodiments of the disclosure, the at least one processor 120 may mean a system on chip (SoC) onto which at least one processor and other electronic components are integrated, a single core processor, a multi core processor, or a core included in the single core processor or the multi core processor, wherein the core may be implemented as a CPU, a GPU, an APU, a MIC, a DSP, a NPU, a hardware accelerator, or a machine learning accelerator but embodiments of the disclosure are not limited thereto.

More particularly, the at least one processor 120 may obtain first audio data including a user voice.

Further, the at least one processor 120 may perform acoustic augmentation on the first audio data to obtain second audio data.

Still further, the at least one processor 120 may obtain a first section corresponding to audio data between time points at which a user speech is included among first audio data and a second section of the second audio data corresponding to the first section.

Next, the at least one processor 120 may calculate a plurality of first scores corresponding to each of a plurality of estimation candidates based on the first audio data corresponding to the first section.

Further, the at least one processor 120 may calculate a plurality of second scores corresponding to each of the plurality of estimation candidates based on the second audio data corresponding to the second section.

Thereafter, the at least one processor 120 may determine one estimation candidate among the plurality of estimation candidates as character data based on the plurality of firs scores and the plurality of second scores.

Meanwhile, the at least one processor 120, if a length of the second section is different from a length of the first section, may calculate a plurality of second scores of each of the plurality of estimation candidates based on a silent section related to the second section.

Further, the at least one processor 120, if the length of the second section is longer than the length of the first section, may calculate a plurality of second scores of each of the plurality of estimation candidates based on the silent section included in the second section.

In addition, the at least one processor 120, if the length of the second section is shorter than the length of the first section, may calculate a plurality of second scores of each of the plurality of estimation candidates based on the silent section removed from the second section.

Meanwhile, the at least one processor 120 may calculate a plurality of first scores related to the plurality of estimation candidates based character data determined at a time point before a time point corresponding to the first section.

Further, the at least one processor 120 may calculate a plurality of second scores related to the plurality of estimation candidates based character data determined at a time point before a time point corresponding to the second section.

Meanwhile, the at least one processor 120 may add up each of the plurality of first scores and the plurality of second scores to calculate a plurality of third scores corresponding to each of the plurality of estimation candidates.

Further, the at least one processor 120 may determine an estimation candidate corresponding to the highest score among the plurality of third scores among the plurality of estimation candidates as character data.

Meanwhile, the at least one processor 120 may determine an estimation candidate corresponding to the highest score among the plurality of first scores and the plurality of second scores among the plurality of estimation candidates as character data.

Meanwhile, the at least one processor 120 may perform acoustic augmentation on the first audio data based on at least one of a speed perturbation, an amplitude perturbation, a vocal track length perturbation (VTLP), or a pitch perturbation with respect to the first audio data to obtain the second audio data.

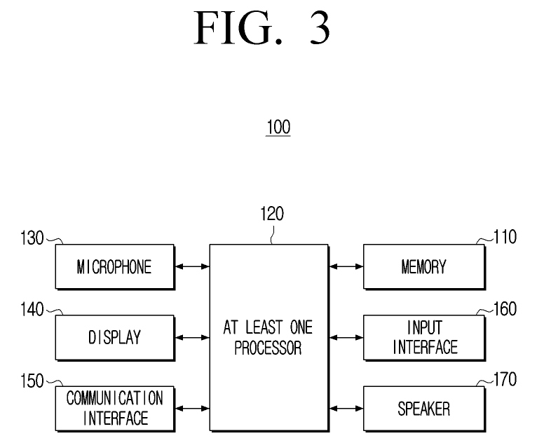

FIG. 3 is a block diagram illustrating a configuration of an electronic device according to an embodiment of the disclosure.

Referring to FIG. 3, an electronic device 100 may include memory 110, at least one processor 120, a microphone 130, a display 140, a communication interface 150, an input interface 160, and a speaker 170. Hereinafter, the detailed description about part overlapped with the description of FIG. 2 is omitted.

The microphone 130 may mean a module obtaining and converting sound to an electric signal and may be a condenser microphone, a ribbon microphone, a moving coil microphone, a piezoelectric element microphone, a carbon microphone, or a micro electro mechanical system (MEMS) microphone. In addition, the microphone may be implemented in an omnidirectional method, a bidirectional method, a unidirectional method, a sub cardioid method, a super cardioid method, or a hyper cardioid method.

More particularly, the microphone 130 may receive audio data including a user speech. Here, the audio data may include a noise incurred by the user speech and a surrounding environment.

The display 140 may include various types of display panels, such as a liquid crystal display (LCD) panel, an organic light emitting diode (OLED) panel, an active-matrix organic light-emitting diode (AM-OLED) panel, a liquid crystal on silicon (LcoS) panel, a quantum dot light-emitting diode (QLED) panel, and a digital light processing (DLP) panel, a plasma display panel (PDP), an organic LED panel, and a micro LED panel but is not limited thereto. Meanwhile, the display 140 may configure a touch screen together with a touch panel and may be configured of a flexible panel.

More particularly, the display 140 may display character data determined by the electronic device 100 recognizing a voice with respect to audio data.

The communication interface 150 may include a wireless communication interface, a wired communication interface, or an input interface. The wireless communication interface may perform communication with various external devices by using a wireless communication technology or a mobile communication technology. This wireless communication technology may include, for example, Bluetooth^{TM}, Bluetooth low energy, controller area network (CAN) communication, Wi-Fi, Wi-Fi direct, ultrawide band (UWB), Zigbee, infrared data association (IrDA), or near field communication (NFC), and the mobile communication technology may include 3^{rd} generation partnership project (3GPP), Wi-Max, long term evolution (LTE), or 5^{th} generation (5G). The wireless communication interface may be implemented by using an antenna, a communication chip, a substrate, and the like which may transmit an electromagnetic wave to the outside or may receive the electromagnetic wave transmitted from the outside. More particularly, the communication interface 150 may obtain an image or receive a movement state designated by a user. More particularly, the communication interface 150 may receive audio data. Otherwise, the electronic device 100 may transmit audio data to an external electronic device or a server through the communication interface 150 and receive character data determined by recognizing a voice with respect to the transmitted audio data from the external electronic device or the server.

The input interface 160 may include a circuit and receive a user command for setting or selecting various functions supported by the electronic device 100. For the above, the input interface 160 may include a plurality of buttons and be implemented as a touch screen capable of performing a function of a display at the same time.

In this case, the at least one processor 120 may control an operation of the electronic device 100 based on the user command inputted through the input interface 160. For example, the at least one processor 120 may control the electronic device 100 based on an on/off command of the electronic device 100, an on/off command of a function of the electronic device 100, or the like inputted through the input interface 160.

More particularly, the input interface 160 may select an operation of the decoder. For example, the input interface 160 may vary a method of calculating a score when determining an estimation candidate as character data according to a user input.

The speaker 170 may output audio sound. Specifically, the at least one processor 120 may output various alarm sound or a voice guidance message related to an operation of the electronic device 100 through the speaker 170.

More particularly, if the character data is determined as a result of voice recognition, the speaker 170 may output the determined character data.

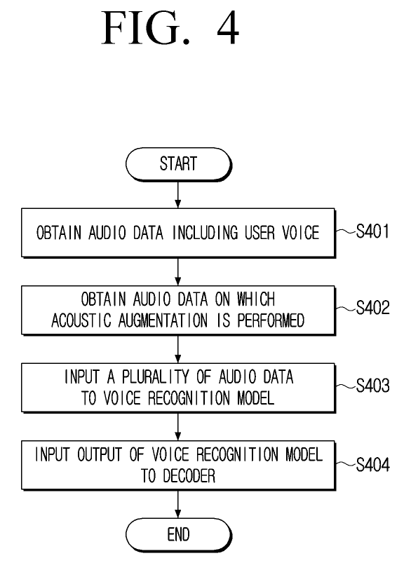

FIG. 4 is a view illustrating a voice recognition process of an electronic device according to an embodiment of the disclosure.

Referring to FIG. 4, the at least one processor 120 may obtain audio data including a user voice at operation S401. Here, the at least one processor 120 may obtain audio data received through a microphone or may receive audio data from a server or an external electronic device through a communication interface. Here, the audio data may include a user voice and a noise.

Further, the at least one processor 120 may obtain a plurality of audio data on which acoustic augmentation is performed at operation S402. Here, the at least one processor 120 may apply at least one of a speed perturbation, an amplitude perturbation, a VTLP, or a pitch perturbation to the audio data to obtain the plurality of audio data on which acoustic augmentation is performed. For example, each of the plurality of audio data may be audio data to which a separate acoustic augmentation method is applied. As above, a method of performing acoustic augmentation on the audio data is an example, and the disclosure is not limited thereto.

Then, the at least one processor 120 may input the plurality of audio data to a voice recognition model at operation S403. Here, the voice recognition model may be an end to end speech recognition model. Here, the end to end speech recognition model may express combination information between voices/languages while making system complexity low by using a single deep neural network. An example of the end to end speech recognition model may include connectionist temporal classification (CTC), an attention model, a recurrent neural network (RNN)-Transducer, or the like.

The voice recognition model may include an encoder. Here, the encoder may obtain information in which a voice characteristic included in input data for voice recognition is converted to a vector on a latent space suitable for voice recognition. Here, the vector on the latent space may be a set of feature values of audio data for calculating scores through an AI neural network.

Further, the voice recognition model may calculate a score of character data corresponding to audio data to be recognized at a current time point. Here, the score of the character data corresponding to the audio data to be recognized at the current time point may be calculated under consideration of a score of character data determined until the previous time point. For example, the score of the character data corresponding to the audio data to be recognized at the current time point may be expressed based on a conditional probability.

Further, the at least one processor 120 may input an output of the voice recognition model to the decoder at operation S404. For example, the decoder may receive a score of character data corresponding to audio data to be currently recognized. Here, the decoder may calculate a score of character data in which character data determined at the previous time point and character data corresponding to audio data to be recognized at the current time point are combined. Then, the at least one processor 120 may determine character data based on the score calculated by the decoder. As above, the decoder may correspond to a beam search process.

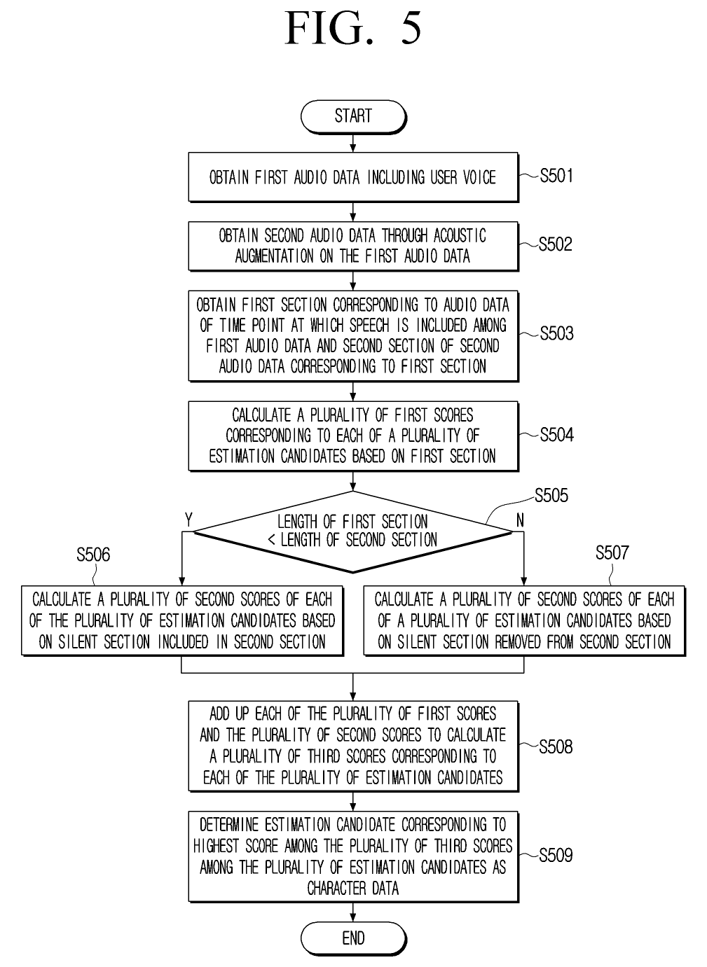

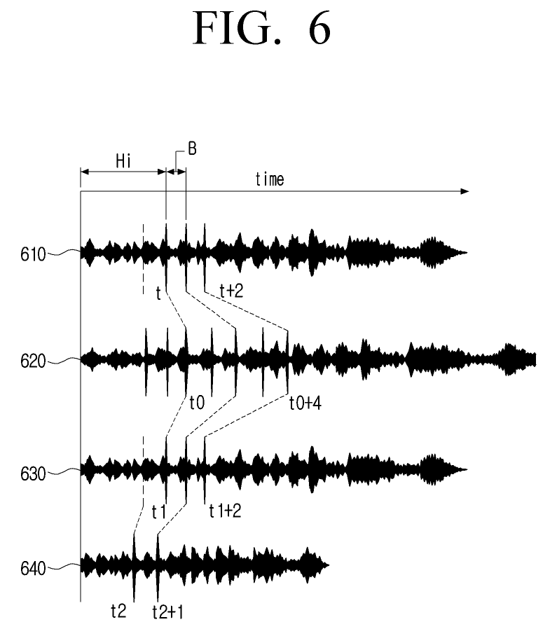

Hereinafter, with reference to FIGS. 5 and 6, is described a process of performing acoustic augmentation on audio data to determine character data and determining character data based on the calculated score.

FIG. 5 is a view illustrating a process of determining character data of an electronic device according to an embodiment of the disclosure.

Referring to FIG. 5, the at least one processor 120 may obtain first audio data including a user voice at operation S501. Here, the at least one processor 120 may obtain first audio data through a microphone or obtain first audio data through a communication interface.

Further, the at least one processor 120 may obtain second audio data through acoustic augmentation on the first audio data at operation S502. Here, the acoustic augmentation may correspond to at least one of a speed perturbation, an amplitude perturbation, a VTLP, or a pitch perturbation. This is an example of acoustic augmentation and is not limited thereto.

Here, a length of the second audio data where acoustic augmentation is performed on the first audio data may be different from a length of the first audio data. As above, if the length of the first audio data and the length of the second audio data are different, the processor may make a section to determine character data correspond thereto and calculate a score with respect to the relevant section.

Therefore, at operation S503, the at least one processor 120 may obtain a first section corresponding to audio data between time points at which a user speech is included among first audio data and a second section of the second audio data corresponding to the first section. Here, the time point at which the user speech is included among the first audio data may be sequentially a time point next to the time point at which the character data corresponding to the first audio data is determined among the entire first audio data. For example, the time point at which the user speech is included among the first audio data may correspond to a time point at which it proceeds with voice recognition on the first audio data. Hereinafter, with reference to FIG. 6, is described the second section of the second audio data corresponding to the first section of the first audio data.

FIG. 6 is a view illustrating a process of obtaining a plurality of first sections and a plurality of second sections according to an embodiment of the disclosure.

Referring to FIG. 6, first audio data 610 may be audio data including a voice of a user and may be an original audio data where there is not any data transformation. Further, a time point to determine character data on the first audio data 610 may be t. Therefore, character data corresponding to the first audio data 610 before the time point t may be determined. Here, the fact that the character data is determined may mean that voice recognition with respect to all and/or part of the audio data is completed. Here, the character data corresponding to the first audio data 610 before the time point t may be determined as “Hi”.

Therefore, the at least one processor 120 may next determine character data with respect to a certain section from the time point t to determine character data on the first audio data 610. Here, the certain section may consist of a plurality of frames. Here, the frame may mean audio data divided by a certain time interval. One frame may consist of audio data in a unit of 10 ms to 20 ms. As above, the certain section may consist of the plurality of frames divided by the unit of 10 ms to 20 ms. Here, if a time point at which one frame starts is t, a time point at which the one frame ends may be expressed with t+1.

For example, the first section corresponding to the audio data between the time points at which the user speech is included among the first audio data 610 may be an interval of time points at which the plurality of frames are configured. For example, if the first section consists of two frames, the first section may correspond to time frames from the time point t to the time point t+2, and if the first section consists of three frames, the first section may correspond to time frames from the time point t to the time point t+3. Hereinafter, for convenience of the description, the first section consists of two frames and is an interval of the time points from the time point t to the time point t+2.

The second audio data is that acoustic augmentation is performed on the first audio data and thus, a length of the second audio data may be different from a length of the first audio data. For example, if the acoustic augmentation is performed on the first audio data through a speed perturbation to reduce a speed of the first audio data by two times, a data length of a second audio data 620 may be two times longer than that of the first audio data 610.

If the data length of the second audio data 620 is two times longer than that of the first audio data 610, the second section corresponding to the first section may be an interval of time points ranging from a time point t0 to four frames. For example, the second section 620 may correspond to an interval of the time points from the time point t0 to t0+4.

Otherwise, if the acoustic augmentation is performed on the first audio data through the speed perturbation to increase the speed of the first audio data by two times, the data length of second audio data 640 may be two times shorter than that of the first audio data.

If the data length of the second audio data 640 is two times shorter than that of the first audio data 630, the second section corresponding to the first section may be an interval of time points ranging from a time point t0 to four frames. For example, the second section may be an interval of the time points from the time point t0 to t0+4.

The at least one processor 120 may determine character data “B” corresponding to the first section based on the first section corresponding to the first audio data from the time point t to the time point t+2, that is, after determining as “Hi” before the time point t.

Hereinafter, a process of calculating a score for determining the character data “B” is described with reference to FIG. 6.

Further, the at least one processor 120 may calculate a plurality of first scores corresponding to each of a plurality of estimation candidates based on the first audio data 610 corresponding to the first section at operation S504. Here, the estimation candidates may correspond to character data which may be included in the first audio data 610 corresponding to the first section. For example, the plurality of estimation candidates may be a plurality of character data having possibility to be included in the first audio data 610 corresponding to the first section. For example, character data which may be included in the first audio data 610 corresponding to the first section may include "A", "B", "C", ... ,"Z”.

Here, the at least one processor 120 may calculate a plurality of first scores corresponding to each of a plurality of estimation candidates based on a score outputted by inputting the first audio data 610 corresponding to the first section to the trained voice recognition model. Here, the at least one processor 120 may calculate a plurality of first scores related to the plurality of estimation candidates based on character data determined at a time point before a time point corresponding to the first section.

Specifically, the first audio data 610 corresponding to the first section is audio data to be currently recognized, wherein the at least one processor 120 may input the first audio data 610 corresponding to the first section to the trained voice recognition model to obtain a score of character data corresponding to audio data to be currently recognized, that is, a conditional probability with respect to the audio data to be currently recognized under a condition of the character data determined until the previous time point, as an output score of the voice recognition model. For example, the output score of the voice recognition model may be expressed as P("B"|"Hi",x_t), which is a probability to determine “B” at the time point t under the condition that “Hi” is determined before the time point t. Here, x_t is the first audio data 610 corresponding to the first section and may be audio data from t to t+2 among the first audio data 610.

Further, the at least one processor 120 may calculate a plurality of first scores corresponding to each of the plurality of estimation candidates based on the output score of the voice recognition model. Here, the plurality of first scores corresponding to each of the plurality of estimation candidates may be not only a score about the plurality of estimation candidates themselves but also a score about a form in which character data determined until the previous time point and estimation candidates are combined. For example, if “Hi” is determined before the time point t and the estimation candidate is “B”, a score corresponding to the estimation candidate “B” may be calculated as P("Hi B").

Here, in case of calculating a score corresponding to the estimation candidate, a silent section may be further considered. Here, the silent section may be a section of the audio data on which a user speech is not included. Here, character data corresponding to the silent section may be expressed as blank data. As above, the blank data may be included as a form of Φ at the end of the determined character data. For example, if “Hi” is determined before the time point t and the estimation candidate is “B”, a score corresponding to the estimation candidate “B” may be calculated as P("HiΦBΦ").

Further, the at least one processor 120 may calculate a plurality of second scores corresponding to each of the plurality of estimation candidates based on the second audio data corresponding to the second section. Here, the at least one processor 120 may calculate a plurality of second scores related to the plurality of estimation candidates based on character data determined at a time point before a time point corresponding to the second section.

Specifically, the second audio data corresponding to the first section is audio data to be currently recognized, wherein the at least one processor 120 may input the second audio data corresponding to the second section to the trained voice recognition model to obtain a score of character data corresponding to audio data to be currently recognized, that is, a conditional probability with respect to the audio data to be currently recognized under the condition of character data determined until the previous time point, as an output score of the voice recognition model. For example, the output score of the voice recognition model may be expressed as P("B"|"Hi",x_t0), which is a probability to determine “B” at the time point t0 under the condition that “Hi” is determined before the time point t0. Here, x_t0 is the second audio data 620 corresponding to the second section and may be audio data from t0 to t0+4 among the second audio data 620.

Further, the at least one processor 120 may calculate a plurality of second scores corresponding to each of the plurality of estimation candidates based on the output score of the voice recognition model. Here, the plurality of second scores corresponding to each of the plurality of estimation candidates may be not only a score about the plurality of estimation candidates themselves but also a score about a form in which character data determined until the previous time point and estimation candidates are combined. For example, if “Hi” is determined before the time point t0 and the estimation candidate is “B”, a score corresponding to the estimation candidate “B” may be calculated as P("Hi B").

Here, in case of calculating a score corresponding to the estimation candidate, a silent section may be further considered. Here, the silent section may be a section of the audio data on which a user speech is not included. Here, character data corresponding to the silent section may be expressed as blank data. As above, the blank data may be included as a form of Φ at the end of the determined character data. Meanwhile, the second audio data is that acoustic augmentation is performed on the first audio data, wherein a data length may be different. In this case, even if a problematic data is determined at the same point, a length of the first section and a length of the second section may be different.

Therefore, the at least one processor 120, if a length of the second is different from a length of the first section, may calculate a plurality of second scores of each of the plurality of estimation candidates based on a silent section related to the second section. For example, the at least one processor 120, if the length of the second section is longer than the length of the first section, needs to further consider blank data, and if the length of the second section is shorter than the length of the first section, may further consider removed blank data to calculate a plurality of second scores.

For the above, the at least one processor may determine whether the length of the second section is longer than the length of the first section at operation S505.

If it is determined at operation S505 the length of the second section is longer than the length of the first section, the at least one processor 120 may calculate each of a plurality of second scores based on the silent section included in the second section and the plurality of estimated candidates at operation S506. For example, if a speed of the second audio data is decreased through acoustic augmentation, the second section corresponding to the first section may be configured to be in a length longer than a length of the first section. Therefore, the second section includes a silent section longer than the silent section included in the first section, wherein if the at least one processor 120 calculates a score under consideration of including the silent section longer than that of the first section, it may determine the estimation candidate as character data under consideration of all of the plurality of first scores with respect to the first section and the plurality of second scores with respect to the second section, wherein data lengths of the first section and the second section are different.

For example, in FIG. 6, if the second audio data 620 of which a speed is decreased by performing acoustic augmentation on the first audio data 610 is obtained, the at least one processor 120 may determine that a length of the second section becomes longer than that of the first section. Here, if a length of the second section is longer than that of the first section by adding a section corresponding to a silent section, the at least one processor 120 may calculate a second score (P(BΦΦ)+P(ΦBΦ)) by adding a probability in which “B” which is one of the plurality of estimation candidates occurs at t0, (P(BΦΦ)), and a probability in which “B” occurs at t0+1, (P(ΦBΦ)).

Meanwhile, if the length of the second section is shorter than the length of the first section, the at least one processor 120 may calculate a plurality of second scores of each of the plurality of estimation candidates based on the silent section removed from the second section at operation S507. For example, if a speed of the second audio data is increased by acoustic augmentation, the second section corresponding to the first section may be configured to be in a length shorter than a length of the first section. Therefore, the second section includes a silent section shorter than the silent section included in the first section or the silent section may be removed, wherein if the at least one processor 120 calculates a score under consideration of the silent section shorter than that of the first section or the removed silent section, the processor may determine the estimation candidate as character data under consideration of all of the plurality of first scores with respect to the first section and the plurality of second scores with respect to the second section, wherein data lengths of the first section and the second section are different.

For example, in FIG. 6, if the second audio data 640 of which a speed is increased by performing acoustic augmentation on the first audio data 610 is obtained, the at least one processor 120 may determine that a length of the second section becomes shorter than that of the first section. Here, if a section corresponding to the silent section is removed and thus, a length of the first section is shorter than that of the second section, the at least one processor 120 may determine that the silent section of the section “Hi” determined previously and the silent section of “B”, which is one of the plurality of estimation candidates are overlapped. Therefore, the at least one processor 120 should correct a score with respect to the overlapped silent section as above to determine an estimation candidate as character data under consideration of all of the plurality of first scores with respect to the first section and the plurality of second scores with respect to second section, wherein data lengths of the first section and the second section are different. For example, if at t2, a score with respect to “HiΦ” is calculated but at t2+1 where the silent section is removed, a probability in which “BΦ” occurs, (P(BΦ)), is calculated, the score is calculated by overlapping Φ corresponding to the silent section. Therefore, the at least one processor 120 may calculate a second score as (1/P(Φ))*P(BΦ)).

Meanwhile, the at least one processor 120 may determine one estimation candidate among the plurality of estimation candidates as character data based on the plurality of firs scores and the plurality of second scores. For example, the at least one processor 120 may determine character data as a final result of voice recognition until the current time point.

Here, the at least one processor 120 may add up each of the plurality of first scores and the plurality of second scores to calculate a plurality of third scores corresponding to each of the plurality of estimation candidates at operation S508. For example, the at least one processor 120 may add up the plurality of first scores corresponding to each of the plurality of estimation candidates calculated based on the first audio data which is original data and the plurality of second scores corresponding to each of the plurality of estimation candidates calculated based on the second audio data which is data on which acoustic augmentation is performed to calculate a plurality of third scores.

Here, as a method of calculating the plurality of third scores, not only an adding up method but also any operation including at least one of addition, multiplication, division, or subtraction may be considered. In addition, the plurality of third scores may be calculated by further considering a weight value with respect to the plurality of first scores and the plurality of second scores.

Further, the at least one processor 120 may determine an estimation candidate corresponding to the highest score among the plurality of third scores among the plurality of estimation candidates as character data at operation S509. As above, if character data is determined by calculating the plurality of third scores, the at least one processor 120 may calculate the plurality of third scores including all of the first scores and the second scores calculated with respect to one estimation candidate and may determine the estimation candidate corresponding to the highest score among the plurality of third scores as character data.

Meanwhile, the at least one processor 120 may determine an estimation candidate corresponding to the highest score among the plurality of first scores and the plurality of second scores among the plurality of estimation candidates as character data. If the character data is determined as above, the at least one processor 120 may determine an estimation candidate corresponding to the highest score among the first scores and the second scores calculated with respect to one estimation candidate as character data.

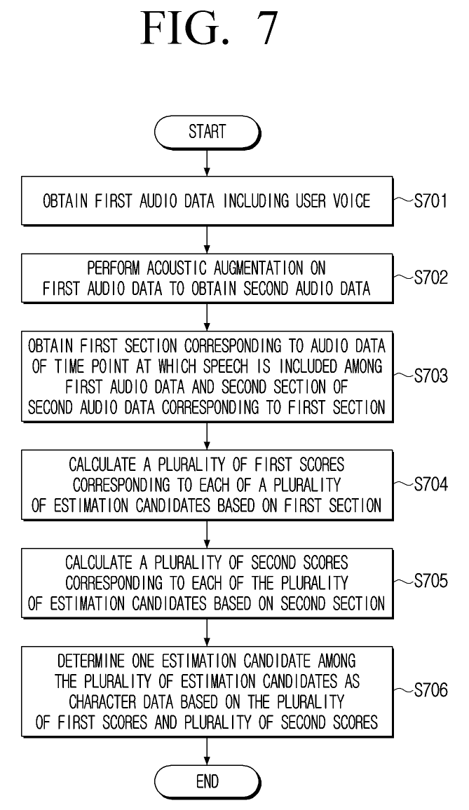

FIG. 7 is a flowchart illustrating a method of controlling an electronic device according to an embodiment of the disclosure.

Referring to FIG. 7, the method may include obtaining first audio data including a user voice at operation S701.

Further, the method may include performing acoustic augmentation on the first audio data to obtain second audio data at operation S702.

Then, the method may include obtaining a first section corresponding to audio data between time points at which a user speech is included among the first audio data and a second section of the second audio data corresponding to the first section at operation S703.

Further, the method may include calculating a plurality of first scores corresponding to each of a plurality of estimation candidates based on the first audio data corresponding to the first section at operation S704.

Further, the method may include calculating a plurality of second scores corresponding to each of the plurality of estimation candidates based on the second audio data corresponding to the second section at operation S705.

Still further, the method may include determining one estimation candidate among the plurality of estimation candidates as character data based on the plurality of first scores and plurality of second scores at operation S706.

The operation S704 may include calculating a plurality of first scores related to the plurality of estimation candidates based on character data determined at a time point before a time point corresponding to the first section.

Meanwhile, the operation S704 may include calculating a plurality of first scores related to the plurality of estimation candidates based on character data determined at a time point before a time point corresponding to the first section.

The operation S705 may include, if a length of the second section is different from a length of the first section, calculating a plurality of second scores of each of the plurality of estimation candidates based on a silent section related to the second section.

Here, if the length of the second section is longer than the length of the first section, the operation may include calculating a plurality of second scores based on the silent section included in the second section and the plurality of estimation candidates.

Alternatively, if the length of the second section is shorter than the length of the first section, the operation may include calculating a plurality of second scores of each of the plurality of estimation candidates based on the silent section removed from the second section.

The operation S705 may include calculating a plurality of second scores related to the plurality of estimation candidates based on character data determined at a time point before a time point corresponding to the second section.

Meanwhile, the operation S705 may include calculating a plurality of second scores related to the plurality of estimation candidates based on character data determined at a time point before a time point corresponding to the second section.

Further, the operation S706 may include adding up each of the plurality of first scores and the plurality of second scores to calculate a plurality of third scores corresponding to each of the plurality of estimation candidates.

Then, the operation may include determining an estimation candidate corresponding to the highest score among the plurality of third scores among the plurality of estimation candidates as character data.

Meanwhile, the operation S706 may include determining an estimation candidate corresponding to the highest score among the plurality of first scores and the plurality of second scores among the plurality of estimation candidates as character data.

Meanwhile, the operation S702 may apply at least one of a speed perturbation, an amplitude perturbation, a vocal track length perturbation (VTLP), or a pitch perturbation to the first audio data and perform acoustic augmentation on the first audio data to obtain the second audio data.

A function related to AI according to the disclosure operates through a processor and memory of the electronic device.

The processor may be configured of one or more processors. Here, the one or more processors may include at least one of a central processing unit (CPU), a graphics processing unit (GPU), or a neural processing unit (NPU) but are not limited to the aforementioned examples of the processors.

The CPU is a general purpose processor capable of performing not only a general operation but also an AI operation and may efficiently perform a complex program through a multilayer cache structure. The CPU is favorable for a series processing method by which an organic connection between the previous calculation result and the next calculation result is possible through a sequential calculation. The general purpose processor is not limited to the aforementioned examples, excluding a case that the disclosure designates it as the aforementioned CPU.

The GPU is a processor for a mass operation, such as a floating point operation used for graphic processing and may integrate cores massively to perform a mass operation in parallel. More particularly, the GPU may be favorable for a parallel processing method, such as a convolution operation compared to the CPU. In addition, the GPU may be used for a co-processor for supplementing a function of the CPU. The processor for the mass operation is not limited to the aforementioned examples, excluding a case that the disclosure designates it as the aforementioned GPU.

The NPU is a processor specific to an AI operation using an artificial neural network, wherein each layer configuring the artificial neural network may be implemented as hardware (e.g., silicon). Here, the NPU is designed to be specific to the specification required by the manufacturer, and thus its degree of freedom is lower than that of the CPU or the GPU but may efficiently perform the AI operation required by the manufacturer. Meanwhile, as a processor specific to the AI operation, the NPU may be implemented as various forms, such as a tensor processing unit (TPU), an intelligence processing unit (IPU), or a vision processing unit (VPU). The AI processor is not limited to the aforementioned examples, excluding a case that the disclosure designates it as the aforementioned NPU.

In addition, the one or more processors may be implemented as a system on chip (SoC). Here, the SoC may further include memory and a network interface, such as a bus for data communication between a processor and the memory besides one or more processors.

If the SoC included in the electronic device includes a plurality of processors, the electronic device may perform an operation related to AI (e.g., an operation related to learning or inference of the AI model) by using a partial processor among the plurality of processors. For example, the electronic device may perform the operation related to the AI by using at least one of a GPU, a NPU, a VPU, a TPU, or a hardware accelerator specific to the AI operation, such as a convolution operation or a matrix product calculation among the plurality of processors. Meanwhile, this is merely an example, and it is obvious that the operation related to the AI may be processed by using a general purpose processor, such as a CPU.

In addition, the electronic device may perform an operation with respect to a function related to AI by using a multicore (e.g., a dual core, a quad core) included in one processor. More particularly, the electronic device may perform the AI operation, such as the convolution operation and the matrix product calculation in parallel by using the multicore included in the processor.

The one or more processors may control the electronic device to process input data according to a predefined operation rule stored in the memory or an AI model. The predefined operation rule or the AI model is constructed by learning.

Here, the construction by learning means that the predefined operation rule or the AI model having a desired characteristic is constructed by applying a learning algorithm to various learning data. This learning may be performed in a device itself where the AI according to the disclosure is performed and may be also performed through a separate server/system.

The AI model may be including a plurality of neural network layers. At least one layer has at least one weight value and performs an operation of the layer through an operation result of the previous layer and at least one defined operation. An example of the neural network is a convolutional neural network (CNN), a deep neural network (DNN), a recurrent neural network (RNN), a restricted Boltzmann machine (RBM), a deep belief network (DBN), a bidirectional recurrent deep neural network (BRDNN), a deep Q-network, or a transformer, wherein the neural network of the disclosure is not limited to the aforementioned example, excluding a case that the neural network is designated as the aforementioned example.

The learning algorithm is a method by which a given target device (e.g., a robot) is trained by using a plurality of learning data such that the given target device may make or predict a decision by itself. An example of the learning algorithm is supervised learning, unsupervised learning, semi-supervised learning, or reinforcement learning, wherein the learning algorithm of the disclosure is not limited to the aforementioned examples, excluding a case that the learning algorithm is designated as the aforementioned examples.

Meanwhile, according to an embodiment of the disclosure, various examples described above may be implemented as software including instructions stored in a machine (e.g., a computer) readable storage medium. The machine may refer to a device which calls instructions stored in the storage medium and is operable according to the called instructions, wherein the machine may include a device according to the disclosed embodiments. If the instructions are executed by a processor, the processor may perform a function corresponding to the instructions directly or by using other components under control of the processor. The instructions may include a code generated or executed by a compiler or an interpreter. The machine readable storage medium may be provided in a form of a non-transitory storage medium. Here, the term ‘non-transitory storage medium’ merely means that the storage medium is a tangible device and does not include a signal (e.g., an electromagnetic wave), wherein the term does not distinguish a case where data is stored semi-permanently in the storage medium from a case where data is stored temporarily therein. For example, the ‘non-transitory storage medium’ may include a buffer where data is temporarily stored.

According to an embodiment of the disclosure, a method according to various examples disclosed in the disclosure may be provided to be included in a computer program product. The computer program product may be traded between a seller and a buyer as goods. The computer program product may be distributed in a form of the machine-readable storage medium (e.g., compact disc read only memory (CD-ROM)) or on-line distributed (e.g., downloaded or uploaded) via an application store (e.g., PlayStore^{TM}) or directly between two user devices (e.g., smart phones). In the case of the on-line distribution, at least part of the computer program product (e.g., a downloadable app) may be stored at least temporarily or may be generated temporarily in the machine-readable storage medium, such as memory of a server of a manufacturer, a server of an application store, or a relay server.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
memory storing one or more computer programs; and
one or more processors communicatively coupled to the memory,
wherein the one or more computer programs include computer-executable instructions that, when executed by the one or more processors individually or collectively, cause the electronic device to:
obtain first audio data including a user voice,
obtain second audio data through acoustic augmentation on the first audio data,
obtain a first section corresponding to audio data between time points at which a user speech is included among the first audio data and a second section of the second audio data corresponding to the first section,
calculate a plurality of first scores corresponding to each of a plurality of estimation candidates based on the first audio data corresponding to the first section,
calculate a plurality of second scores corresponding to each of the plurality of estimation candidates based on the second audio data corresponding to the second section, and
determine one estimation candidate among the plurality of estimation candidates as character data based on the plurality of first scores and the plurality of second scores.

2. The electronic device of claim 1, wherein the one or more computer programs further include computer-executable instructions that, when executed by the one or more processors individually or collectively, cause the electronic device to:
based on a length of the second section being different from a length of the first section, calculate a plurality of second scores of each of the plurality of estimation candidates based on a silent section related to the second section.

3. The electronic device of claim 2, wherein the one or more computer programs further include computer-executable instructions that, when executed by the one or more processors individually or collectively, cause the electronic device to:
based on the length of the second section being longer than the length of the first section, calculate each of a plurality of second scores based on the silent section included in the second section and the plurality of estimated candidates.

4. The electronic device of claim 2, wherein the one or more computer programs further include computer-executable instructions that, when executed by the one or more processors individually or collectively, cause the electronic device to:
based on the length of the second section being shorter than the length of the first section, calculate a plurality of second scores of each of the plurality of estimation candidates based on the silent section removed from the second section.

5. The electronic device of claim 1, wherein the one or more computer programs further include computer-executable instructions that, when executed by the one or more processors individually or collectively, cause the electronic device to:
calculate a plurality of first scores related to the plurality of estimation candidates based on character data determined at a time point before a time point corresponding to the first section.

6. The electronic device of claim 1, wherein the one or more computer programs further include computer-executable instructions that, when executed by the one or more processors individually or collectively, cause the electronic device to:
calculate a plurality of second scores related to the plurality of estimation candidates based on character data determined at a time point before a time point corresponding to the second section.

7. The electronic device of claim 1, wherein the one or more computer programs further include computer-executable instructions that, when executed by the one or more processors individually or collectively, cause the electronic device to:
add up each of the plurality of first scores and the plurality of second scores to calculate a plurality of third scores corresponding to each of the plurality of estimation candidates, and
determine an estimation candidate corresponding to a highest score among the plurality of third scores among the plurality of estimation candidates as the character data.

8. The electronic device of claim 1, wherein the one or more computer programs further include computer-executable instructions that, when executed by the one or more processors individually or collectively, cause the electronic device to:
determine an estimation candidate corresponding to a highest score among the plurality of first scores and the plurality of second scores among the plurality of estimation candidates as the character data.

9. The electronic device of claim 1, wherein the one or more computer programs further include computer-executable instructions that, when executed by the one or more processors individually or collectively, cause the electronic device to:
apply at least one of a speed perturbation, an amplitude perturbation, a vocal track length perturbation (VTLP), or a pitch perturbation to the first audio data; and
perform acoustic augmentation on the first audio data to obtain the second audio data.

10. A method performed by an electronic device, the method comprising:
obtaining, by the electronic device, first audio data including a user voice;
obtaining, by the electronic device, second audio data through acoustic augmentation on the first audio data;
obtaining, by the electronic device, a first section corresponding to audio data between time points at which a user speech is included among the first audio data and a second section of the second audio data corresponding to the first section;
calculating, by the electronic device, a plurality of first scores corresponding to each of a plurality of estimation candidates based on the first audio data corresponding to the first section;
calculating, by the electronic device, a plurality of second scores corresponding to each of the plurality of estimation candidates based on the second audio data corresponding to the second section; and
determining, by the electronic device, one estimation candidate among the plurality of estimation candidates as character data based on the plurality of first scores and the plurality of second scores.

11. The method of claim 10, wherein the calculating of the plurality of second scores includes:
based on a length of the second section being different from a length of the first section, calculating a plurality of second scores of each of the plurality of estimation candidates based on a silent section related to the second section.

12. The method of claim 11, wherein the calculating of the plurality of second scores includes:
based on the length of the second section being longer than the length of the first section, calculating each of a plurality of second scores based on the silent section included in the second section and the plurality of estimated candidates.

13. The method of claim 11, wherein the calculating of the plurality of second scores includes:
based on the length of the second section being shorter than the length of the first section, calculating a plurality of second scores of each of the plurality of estimation candidates based on the silent section removed from the second section.

14. The method of claim 10, wherein the calculating of the plurality of first scores includes:
calculating a plurality of first scores related to the plurality of estimation candidates based on character data determined at a time point before a time point corresponding to the first section.

15. The method of claim 10, further comprising:
calculating a plurality of second scores related to the plurality of estimation candidates based on character data determined at a time point before a time point corresponding to the second section.

16. The method of claim 10, further comprising:
adding up each of the plurality of first scores and the plurality of second scores to calculate a plurality of third scores corresponding to each of the plurality of estimation candidates; and
determining an estimation candidate corresponding to a highest score among the plurality of third scores among the plurality of estimation candidates as the character data.

17. The method of claim 10, further comprising:
determining an estimation candidate corresponding to a highest score among the plurality of first scores and the plurality of second scores among the plurality of estimation candidates as the character data.

18. The method of claim 10, further comprising:
applying at least one of a speed perturbation, an amplitude perturbation, a vocal track length perturbation (VTLP), or a pitch perturbation to the first audio data; and
performing acoustic augmentation on the first audio data to obtain the second audio data.

19. One or more non-transitory computer-readable storage media storing one or more computer programs including computer-executable instructions that, when executed by one or more processors of an electronic device individually or collectively, cause the electronic device to perform operations, the operations comprising:
obtaining, by the electronic device, first audio data including a user voice;
performing, by the electronic device, acoustic augmentation on the first audio data to obtain second audio data;
obtaining, by the electronic device, a first section corresponding to audio data between time points at which a user speech is included among the first audio data and a second section of the second audio data corresponding to the first section;
calculating, by the electronic device, a plurality of first scores corresponding to each of a plurality of estimation candidates based on the first audio data corresponding to the first section;
calculating, by the electronic device, a plurality of second scores corresponding to each of the plurality of estimation candidates based on the second audio data corresponding to the second section; and
determining, by the electronic device, one estimation candidate among the plurality of estimation candidates as character data based on the plurality of first scores and the plurality of second scores.

20. The one or more non-transitory computer-readable storage media of claim 19, the operations further comprising:
based on a length of the second section being different from a length of the first section, calculating a plurality of second scores of each of the plurality of estimation candidates based on a silent section related to the second section.
